(19) United States
(12) Patent Application Publication
(10) Pub. No.: US 2024/0023748 A1
(43) Pub. Date: Jan. 25, 2024

(54) BEAN TO BATCH BREWER

(71) Applicant: BUNN-O-MATIC CORPORATION, Springfield, IL (US)

(72) Inventors: Jason M. BANNING, Springfield, IL (US); Mark W. BANDIXEN, Springfield, IL (US); Jonathan CLARK, Springfield, IL (US); Joel MORTON, Springfield, IL (US); David HELBLING, Springfield, IL (US)

(21) Appl. No.: 18/200,317

(22) Filed: May 22, 2023

Related U.S. Application Data
(60) Provisional application No. 63/344,441, filed on May 20, 2022.

(51) Int. Cl. A47J 31/40; A47J 31/60

(52) U.S. Cl. CPC A47J 31/402; A47J 31/60

(57) ABSTRACT

A beverage making and dispensing apparatus for controllably preparing batches of beverage. The beverage making and dispensing apparatus includes a housing, a controller, a user interface carried on the housing and operatively associated with the controller. A beverage making engine is associated with the housing and is controllably operated by the controller. The brew engine controllably receives a predetermined quantity of beverage making substance and beverage making liquid for producing a predetermined beverage. At least a plurality of reservoirs are individually, operatively associated with the apparatus and retained in the housing. Each reservoir is controllably operatively in communication with the beverage making engine to controllably, individually receive separate batches of beverage produced by the beverage making engine. Beverage is selectively, controllably dispensable from each reservoir on demand by selective controllable operation of a dispensing valve communicating with each reservoir.

### CROSS REFERENCE TO RELATED APPLICATIONS

This application claims the benefit of priority under 35 U.S.C. § 119(e) to U.S. Provisional Patent Application No. 63/344,441, filed May 20, 2022. The disclosure set forth in the referenced application is incorporated herein by reference in its entirety.

This application also incorporates herein by reference in their entirety the subject matter of the following applications and patent which are owned in the entirety by the Applicant of the present application, including U.S. patent application Ser. No. 17/048,882, filed Oct. 19, 2020, International application no. PCT/US2019/028367, filed Apr. 19, 2019, which claims priority to U.S. Provisional Application No. 62/660,085, filed Apr. 19, 2018, U.S. Pat. No. 8,950,318, issued Feb. 10, 2015, and the materials in the attached Appendix A and Appendix B.

### BACKGROUND

The present disclosure includes a beverage making and dispensing apparatus, method and system for controllably preparing batches of beverage from beverage making substance such as fresh ground coffee beans. The present disclosure overcome numerous problems associated with prior systems that produce fresh coffee from fresh ground beans. One of the problems that is overcome is the provision of a brewer that can accommodate several reservoirs to hold separate batches of fresh brewed coffee and a selectively controlled dispensing of coffee from those reservoirs on demand. The prior art also has issues with the space management of multiple reservoirs associated with a single brewer often requiring movement of various reservoirs to and from a brewing dispense point.

The present disclosure also includes solutions to problems associated with inconsistent distribution of total dissolved solids within a brewed beverage. The present disclosure provides a solution to this problem that also can be used to solve a problem associated with cleaning of solids and fines which can be left behind within and on the internal surfaces of a reservoir. Another issue associated with the present disclosure is the reduction of heat loss in the brewed beverage being dispensed from the reservoirs when multiple reservoirs are contained in the overall apparatus. A structure is provided in the present disclosure that helps reduce the heat loss and possible overspray of coffee being dispensed during the brewing process.

The present disclosure also provides systems and methods for scheduling the dispensing into reservoirs and the operation of the brewer. This system operation as well as a controllable dashboard that provides a virtual relationship to the physical reservoir is used to help manage the control of the brewer and the dispensing into the various reservoirs.

The present disclosure also provides information about the use of proximity sensing to help enhance brewer readiness and provide attractive indicia when a potential customer is detected.

The present disclosure also relates to a simulation system that overcomes problems with apparatus operators capturing data and understanding product availability, apparatus maintenance, and waste reduction among other factors impacting brewer operations and productivity.

Also provided is an on demand dispensing option to provide single cup dispensing on demand without having to have a full reservoir.

In addition, a variable pour handle/faucet system is provided to provide a digitally controlled faucet dispensing system which is analogous to a physical dispensing faucet.

This background information is provided to provide some information believed by the applicant to be of possible relevance to the present disclosure. No admission is intended, nor should such admission be inferred or construed, that any of the preceding information constitutes prior art against the present invention. Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

The present disclosure will be described hereafter with reference to the attached drawings which are given as a non-limiting example only, in which:

FIG. 1 is a perspective view of a brewing apparatus as set forth in the disclosure, the brewing apparatus includes a brew engine that receives fresh coffee beans from hoppers positioned proximate thereto for delivery of bean to a grinder operatively associated with the brew engine, a user interface is provided to control the brew engine and dispensing of beans from the hopper, a reservoir housing is associated with the apparatus to receive fresh brewed coffee from the brew engine and for controllable dispensing therefrom at a dispensing point located on the housing of the apparatus;

FIG. 2 is an enlarged partial fragmentary view of an interior perspective of the reservoir housing shown in FIG. 1 showing the relationship between multiple reservoirs and a docking assembly associated with the housing, associated controllable pumps and corresponding plumbing are provided below the reservoirs to transport brewed beverage from the reservoirs to the dispensing point upon control at the user interface;

FIG. 3 is an enlarged perspective view of a docking tray showing a docking port which cooperatively engages a corresponding reservoir port positioned on the bottom area of the reservoir;

FIG. 4 is an enlarged view of a reservoir removed from the reservoir housing showing the body of the reservoir and including a reservoir port on the bottom portion of the reservoir for communication and engagement with the docking port of the docking tray as shown in FIGS. 2 and 3, an asymmetrically located handle is provided which is also shown in FIG. 2, to facilitate better gripping and leverage when inserting and removing reservoirs from a compartment defined within the reservoir housing;

FIG. 5 is an enlarged cross sectional view of the reservoir port engaging the docking port in the docking tray to show the alignment and engagement between these structures facilitating preventing drip or leakage when engaging the components of the reservoir port with the docking port, the docking port providing a protruding portion 55 to disengage a corresponding normally biased closed member within the reservoir port so as to open a path from the internal cavity of the reservoir through the reservoir port and into the docking port which also communicates with the pumps and plumbing as previously described;

FIG. 6 is a bottom view of the reservoir as shown in FIG. 4 illustrating the displaceable member described with regard to FIG. 5 and also illustrating conductive contact points on the bottom of the reservoir for mating with corresponding conductive points in the docking tray as shown in FIG. 3, engagement of the reservoir conductive contact points with the docking tray conductive contact points providing a communication path for communicating information about the characteristics of the reservoir as well as the contents of the reservoir including positioning of the reservoir in the docking tray, the life of the beverage in the reservoir, the level of the contents of the reservoir, and other characteristics;

FIG. 7 shows a side, cross sectional, elevational view of a reservoir engaged in the docking tray as shown in FIG. 2 further illustrating components associated with the pumps and plumbing as described in FIG. 2 to facilitate injection of air through the plumbing and into the reservoir, the air injection port being used to facilitate agitation of brewed beverage within the reservoir to facilitate generally even distribution of dissolved solids within the liquid beverage and enhance entrainment of solids within the liquid portion, and to facilitate agitation of liquid and cleaning products within the reservoir during a clean-in-place cleaning cycle;

FIG. 8 is an enlarged perspective view of the plumbing and pump portion as described in FIG. 2 showing an air agitation port connected to the dispense line extending downwardly from the reservoir engaged with the dispense line via the docking port and reservoir port, air agitation being provided as a result of an air pump controllably operated by a controller associated with the apparatus to facilitate controlled movement of air through the air passage into the dispensing line with the air following the path of least resistance upwardly through the dispensing line into the reservoir, agitation of the air in the liquid beverage causing mixing of the dissolved solids with the beverage as described;

FIG. 9 is an enlarged perspective view of a series of level sensors contained within the server and positioned along the server wall as also shown in FIG. 7 to facilitate controllable monitoring of the condition of coffee or other beverages within the server, also showing in FIG. 9 and internal perspective of the reservoir port showing the displaceable portion retained within the port;

FIG. 10 is an enlarged perspective view of the reservoirs retained in the reservoir housing showing a swing arm apparatus extending downwardly from an upper portion of the reservoir for facilitating controlled positive location of brewer for dispensing brewed beverage from the brewer into a top opening in the corresponding reservoirs;

FIG. 11 is top perspective view taken above the area defining a top portion of the reservoir housing cavity showing brewer dispense lines extending downwardly through holes therein for communication of coffee for dispensing into each of the three reservoirs as shown in the illustrations;

FIG. 12 is a perspective view below the panel as shown in FIG. 11 in which the dispensing lines extend downwardly through the plane and into the assembly wherein the end ports are retained on the assembly and can be controllably directed by the hinged movement of the swing arm assembly, also showing magnetic contacts, one on the plane and one on the assembly for retained engagement of the arm in an up position to move the end ports out of the way while moving reservoirs into and out of the reservoir housing cavity; and

FIG. 13 shows a perspective view in which the swing arm is positioned downwardly directing the dispensing lines downwardly over corresponding reservoirs (not shown in FIG. 13) such as those aligned in FIG. 2, with secondary magnetic couplings on a spaced apart location of the assembly from the first magnetic couplings, engaging corresponding couplings on the plane to retain the assembly in a downward position for dispensing, the magnetic couplings and/or sensors providing positive detection of the position of the assembly to controllably operate or block operation of the dispensing of beverage from the brewer to the reservoirs depending on the location of the end ports.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

Terms including beverage, brewed, brewing, brewing substance, brewed liquid, and brewed beverage as may be used herein are intended to be broadly defined as including, but not limited to, the brewing of coffee, tea and any other beverages. This broad interpretation is also intended to include, but is not limited to any process of dispensing, infusing, steeping, reconstituting, diluting, dissolving, saturating or passing a liquid through or otherwise mixing or combining a beverage substance with a liquid such as water without limitation to the temperature of such liquid unless specified. This broad interpretation is also intended to including, but is not limited to beverage substances such as ground coffee, tea, liquid beverage concentrate, powdered beverage concentrate, flaked, granular, freeze dried or other forms of materials including liquid, gel, crystal or other forms of beverage or food materials to obtain a desired beverage or other food product.

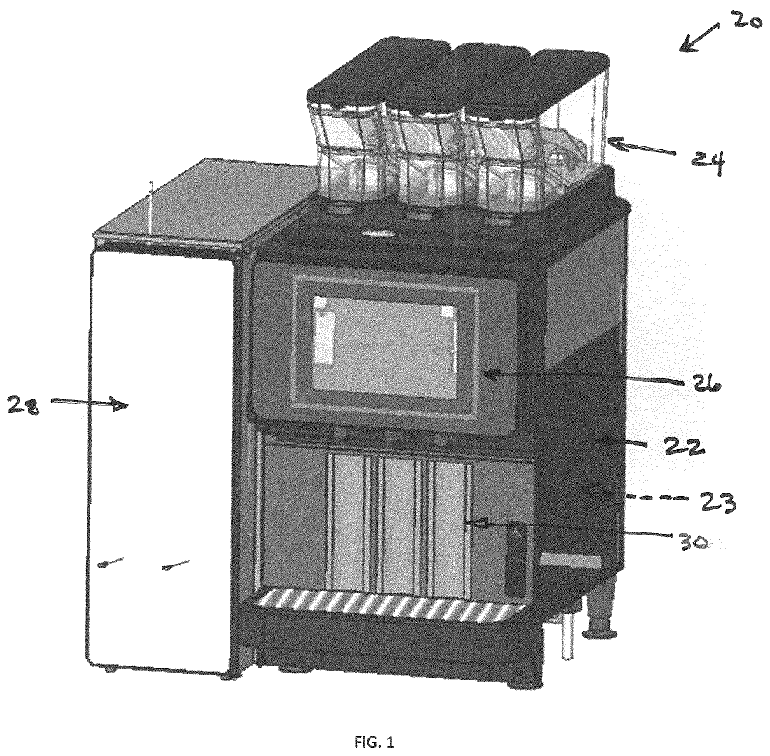

As shown in FIG. 1, a beverage making and dispensing apparatus 20 includes a housing 22 which contains a brewer assembly 23 (not specifically shown herein) such as the device disclosed and shown in co-pending U.S. patent application Ser. No. 17/048,882 filed Oct. 19, 2020 and claiming priority to the applications indicated above. The beverage making and dispensing apparatus, method and system controllably prepare batches of beverage from beverage making substance such as fresh ground coffee beans. The brewer assembly 23 or “brew engine” is used to produce controlled, pre-determined quantities of freshly brewed beverage from freshly ground coffee beans which are retained in one or more hoppers 24 positioned proximate to the brew engine 23 for grinding and delivery to the brew engine 23. A user interface 26 is provided on an exterior portion of the housing 22 to allow a user to control the operation of the brewer. The user interface includes a controller for selectively operatively controlling the apparatus to make and dispense beverages. A reservoir housing 28 is provided next to and controllably associated with the overall apparatus. Coffee is brewed from the fresh ground beans in the brew engine 23 and transferred to reservoirs retained within the reservoir housing 28. Coffee can then be controllably dispensed on demand for dispending at a dispensing point 30 located generally proximate to the user interface 26.

The beverage making engine 23 associated with the housing 20, and controllably operated by the controller. The brew engine 23 controllably receiving a predetermined quantity of beverage making substance and beverage making liquid for producing a predetermined beverage. At least a plurality of reservoirs 40, 41 individually operatively associated with the apparatus and retained in the housing. Each reservoir controllably operatively communicating with the beverage making engine 23 to controllably, individually receive separate batches of beverage produced by the beverage making engine. Beverage selectively, controllably dispensable from each reservoir on demand by selective controllable operation of a dispensing valve communicating with each reservoir.

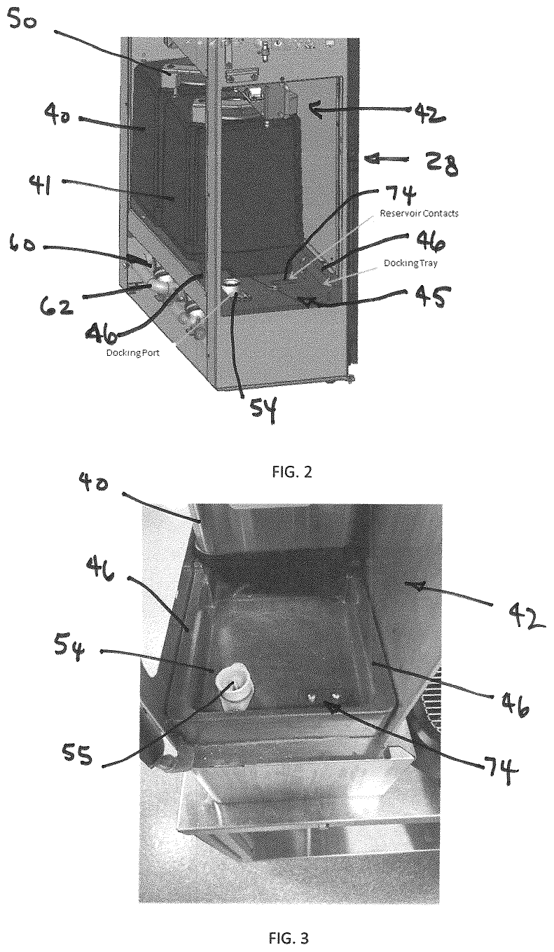

As shown in FIGS. 2-6 a series of reservoirs 40, 41 are shown in a cavity 42 of the reservoir housing 28. A docking tray 45 is provided in a lower section of the housing 28 for receiving reservoirs thereon. The docking tray 45 includes a pair of spaced apart rails 46, 46 that allows the correspondingly designed reservoir 40 to slide there along when positioning it in the cavity 42. An asymmetrically positioned handle 50 is positioned on an upper portion of the reservoir 40 offset therefrom to allow the oriented positioning of the reservoirs within the cavity 42. The asymmetric design allows for better gripping and/or leverage when installing and removing reservoirs from the cavity 42.

A lower portion of the reservoir includes a reservoir port 52 and a corresponding docking port 54 is provided on the docking tray 45. As shown in FIG. 5, the docking ports 52, 54 engage one another to allow the normally biased closed reservoir port 52 having a displaceable closure 56 to be biased upwardly by a protruding portion 55 to allow the passage of beverage retained in the reservoir 40 from the reservoir and through the docking port 54. Coffee is retained in this passage until it is controllably pumped by the pumps 60 and corresponding plumbing 62 to move the coffee from the reservoir 40 to the dispensing point 30.

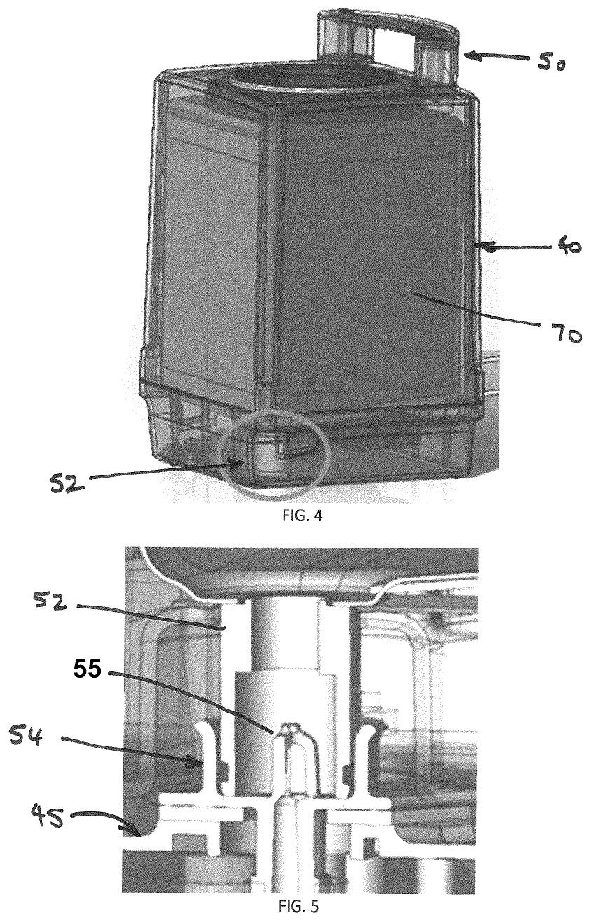

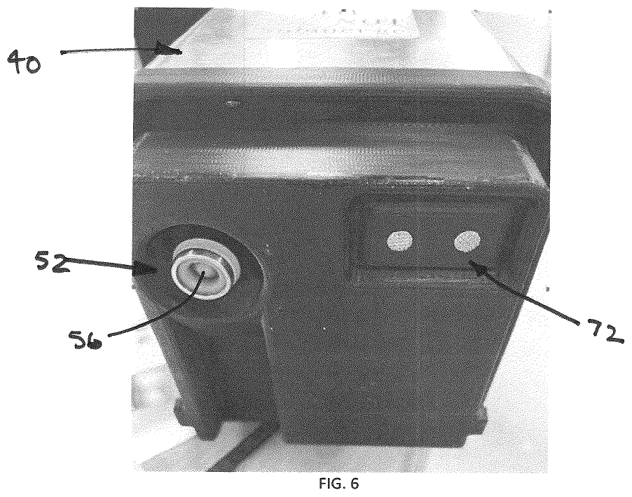

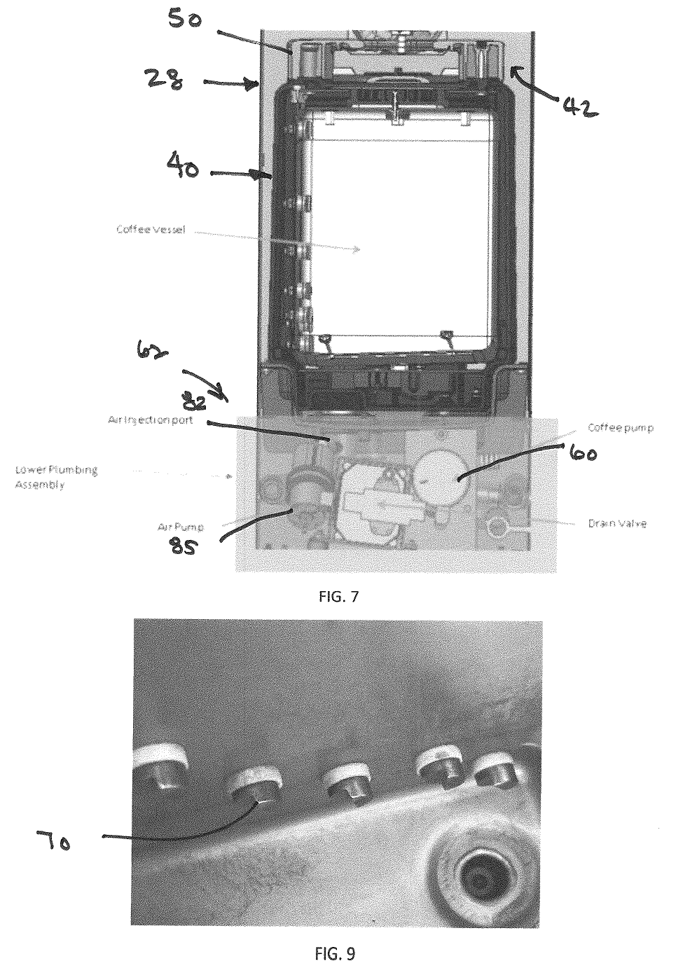

A series of sensors and contacts are provided on the reservoir, first a series of level sensors 70 are attached to an interior surface of the reservoir as shown in FIGS. 7 and 9. These contact points are also shown in FIG. 4. In addition, reservoir contacts 72 are provided on the bottom of the reservoir (see FIG. 6) which engage corresponding tray contacts 74 on the tray. Engagement of the reservoir and tray contacts 72, 74 provides a conductive path to communicate information about the characteristics of beverage retained in the reservoir.

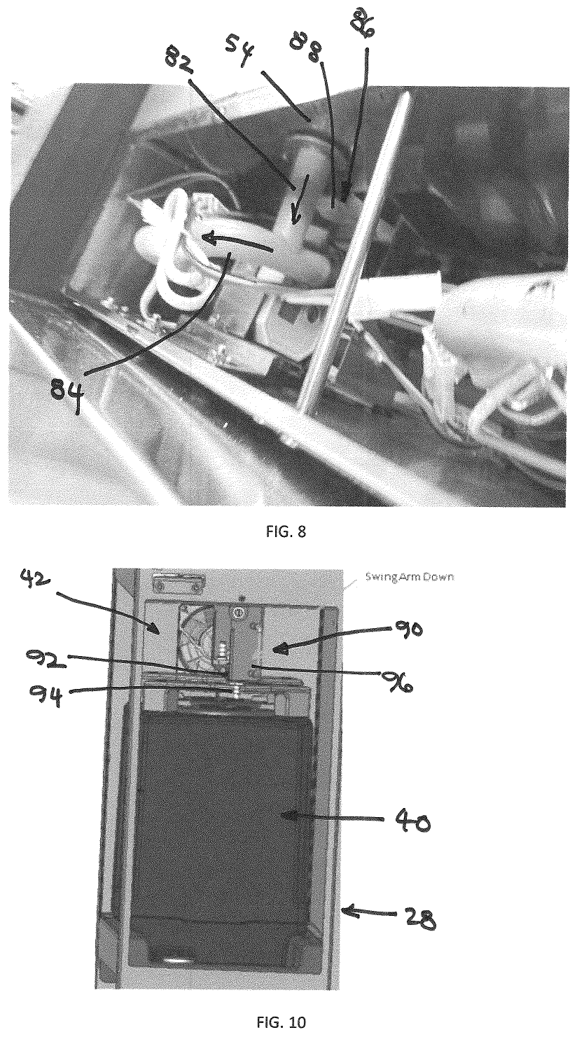

An air injection assembly is shown in FIGS. 7 and 8 in which an air injection line 86 is connected to and communicates with a dispensing line 82. The dispensing line 82 directly communicates with the contents of the reservoir through the reservoir port 52 and the docking port 54. The dispense line 82 as shown in FIG. 8 generally is directed downwardly to an additional feed line 84 that is pumped to controllably deliver beverage to the dispense point 30. A controller controls all of the systems in the apparatus 20 by way of appropriate software coding. An air pump 85 is attached to an airline 86 which communicates with the dispensing line 82. When the air pump 85 is controllably operated air is fed through the air line 86 into the dispense line 82. Following the path of least resistance upwardly into the dispense line 82 and the reservoir, the air agitation moves liquid each reservoir to help to agitate and mix the contents of the reservoir. Air agitation is beneficial to beverages retained in the reservoirs to provide movement of dissolved solids and, perhaps, fines within the liquid to prevent precipitation and settling of these components out of solution. The air injection line 86 is also used to facilitate agitation of liquid and cleaning products within the reservoir to enhance thorough cleaning during a clean-in-place cleaning cycle by moving cleaning products used in the cleaning cycle throughout and over the interior surfaces of the reservoir. A normally closed check valve 88 is provide on the air line 86 to prevent the backflow of liquid into the air line 86 when the pump 85 is not operated.

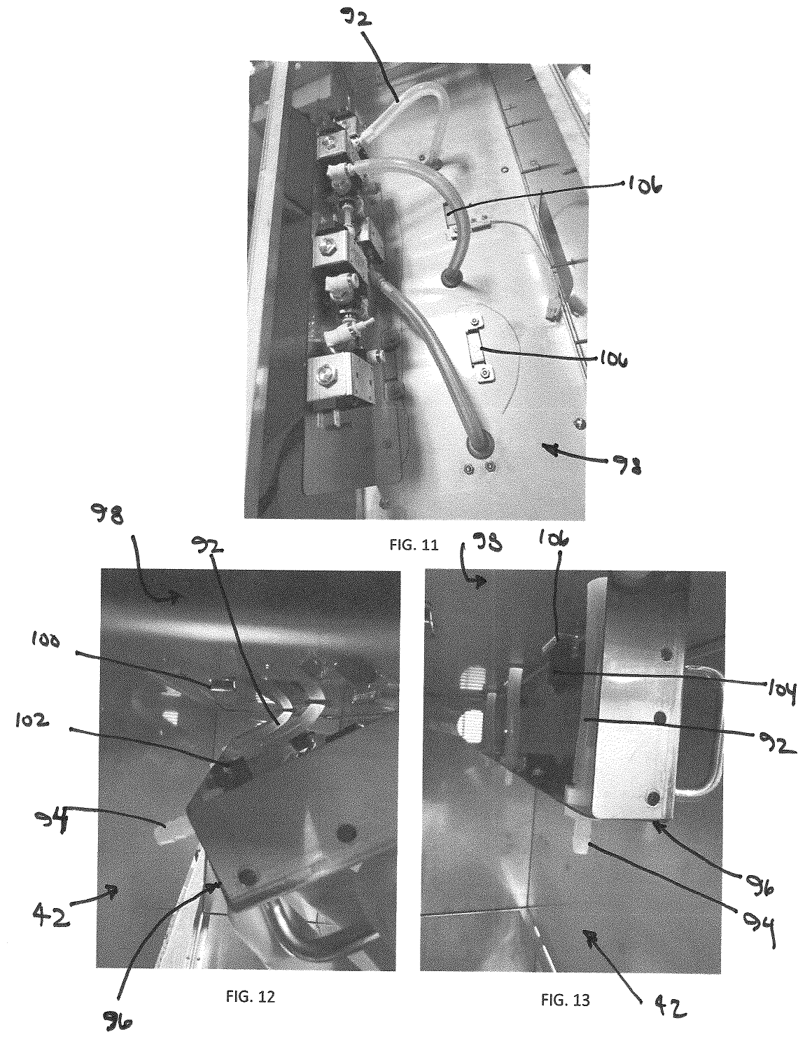

As shown in FIGS. 10-13 a swing arm assembly 90 is provided to controllably position brew dispense lines 92 and the end ports 94 thereof relative to reservoirs contained within the reservoir cavity. The swing arm assembly 90 includes a structure 96 that can be pivoted relative to an internal housing structure 98. The structure 96 is attached to the housing portion 98 by means of a hinge. Other attachments can be used for this purpose. A first set of engagement magnets 100, 102 are provided on the structures 96, 98 to positively retain the structure 96 upwardly. Sensors provided on the assembly 90 are through the magnets 100, 102 provide feedback to the controller of the apparatus 20 to indicate that the assembly 90 is in the upward position. This prevents dispensing through the dispense lines 92. A second set of magnets 104, 106 are used to retain the assembly 90 in the downward or dispensing position. Similarly, sensors are provide to indicate to the controller of the apparatus 20 that the lines 92 and the end ports 94 are in position for dispensing.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A beverage making and dispensing apparatus for controllably preparing batches of beverage, the beverage making and dispensing apparatus comprising:
a housing;
a controller;
a user interface carried on the housing and operatively associated with the controller;
a beverage making engine associated with the housing, and controllably operated by the controller, the brew engine controllably receiving a predetermined quantity of beverage making substance and beverage making liquid for producing a predetermined beverage;
at least a plurality of reservoirs individually operatively associated with the apparatus and retained in the housing, each reservoir controllably operatively communicating with the beverage making engine to controllably, individually receive separate batches of beverage produced by the beverage making engine; and
beverage selectively, controllably dispensable from each reservoir on demand by selective controllable operation of a dispensing valve communicating with each reservoir.

2. The beverage making and dispensing apparatus for controllably preparing batches of beverage of claim 1, the beverage making and dispensing apparatus further comprising: an agitation system for moving liquids retained in each reservoir.

3. The beverage making and dispensing apparatus for controllably preparing batches of beverage of claim 2, the beverage making and dispensing apparatus wherein the liquid is the beverage produced by the beverage making engine and dispensed into the reservoir with the agitation system mixing the solids and fines in the produced beverage for a more consistent dispensed beverage.

4. The beverage making and dispensing apparatus for controllably preparing batches of beverage of claim 2, the beverage making and dispensing apparatus wherein the liquid is a cleaning product that is dispensed into a reservoir for cleaning the reservoir.
